(19) United States
(12) Patent Application Publication
(10) Pub. No.: US 2012/0160020 A1
(43) Pub. Date: Jun. 28, 2012

(54) APPARATUS AND METHOD FOR MOISTURE DETECTION IN A REFRIDGERANT/OIL MIXTURE

(76) Inventor: Roger Burger, Winona Lake, IN (US)

(21) Appl. No.: 12/977,869

(22) Filed: Dec. 23, 2010

(51) Int. Cl. G01N 5/02; F25B 43/00

(52) U.S. Cl. 73/73; 62/468; 62/192

(57) ABSTRACT

A heat transfer device, including an evaporator, a condenser, a compressor fluidly coupled to the evaporator and the condenser. A refrigerant/oil mixture is routed to the compressor, the evaporator, and the condenser. An apparatus for moisture detection in the refrigerant/oil mixture includes the apparatus being in fluid communication with the mixture. The apparatus includes a refractive index determining device, a dielectric constant determining device, and a controller. The refractive index determining device produces a first signal representative of a refractive index of the mixture. The dielectric constant determining device produces a second signal representative of a dielectric constant of the mixture. The controller receives the first signal and the second signal. The controller determines a moisture content of the mixture dependent upon the first signal and the second signal.

### BACKGROUND OF THE INVENTION

1. Field of the Invention

The present invention relates generally to a heat transfer device and, more particularly to the detection of moisture in the refrigerant/oil mixture used in a heat transfer device.

2. Description of the Related Art

In a conventional heat transfer device, as shown in FIG. 1, device 10 includes a condenser 12, an evaporator 14, fluid lines 16, 18, and 20, a compressor 22, a filter receiver/dryer 24, an expansion valve 26, pressure switches 28 and 30, and service ports 32 and 34. Warm airflow 36 passes through evaporator 14, giving up heat to evaporator 14 and the refrigerant passing therethrough. This cools the air and results in cool airflow 38 being directed to a room or passenger compartment of a vehicle. The heat is then transferred to condenser 12 by action of compressor 22 where the heat then is transferred to the environment by passing an airflow 40 through condenser 12 to thereby result in heated air flow 42 passing through condenser 12 and transferring heat from refrigerant passing through condenser 12 to the ambient environment. One of the problems with a heat transfer device is the destructive effects of moisture that may be contained in the refrigerant/oil mix.

A problem related to the operation of heat transfer devices, refrigeration systems, air conditioning systems and other systems using a refrigerant/oil mixture is damage to such equipment caused by moisture or water in the refrigerant. Moisture in the system can cause acid formation which is destructive to the internal parts of the system. For example, a motor having windings exposed to the refrigerant are vulnerable to the presence of water and moisture related contaminants. Water enters the refrigerant through leaking gaskets, pipes, tubes, joints, malfunctions of charging systems. Even only a few drops of water in the refrigerant can lead to the formation of a sufficient level of acid to cause failure of the system due to continued operation with the acid or contaminants that may result from the action of the acid in the refrigerant. Another problem is that the moisture causes the reduction of lubrication properties of the oil as it absorbs some moisture causing premature wear of parts in the compressor. A significant percentage of failures of heat transfer equipment is caused by the presence of water and water related contaminants in the refrigerant.

What is needed in the art is an easy, cost-effective apparatus and method of detecting moisture in the refrigerant/oil mixture.

### SUMMARY OF THE INVENTION

In one aspect, the invention consists of a heat transfer device, including an evaporator, a condenser, a compressor fluidly coupled to the evaporator and the condenser. A refrigerant/oil mixture is routed to the compressor, the evaporator, and the condenser. An apparatus for moisture detection in the refrigerant/oil mixture includes the apparatus being in fluid communication with the mixture. The apparatus includes a refractive index determining device, a dielectric constant determining device, and a controller. The refractive index determining device produces a first signal representative of a refractive index of the mixture. The dielectric constant determining device produces a second signal representative of a dielectric constant of the mixture. The controller receives the first signal and the second signal. The controller determines a moisture content of the mixture dependent upon the first signal and the second signal.

Another aspect of the present invention consists of a method of determining a moisture content of a refrigerant/oil mixture of a heat transfer device. The method includes the steps of testing the mixture to determine a refractive index of the mixture, testing the mixture to determine a measured dielectric constant of the mixture, estimating a dielectric constant of the mixture dependent upon the refractive index, determining the moisture content of the mixture dependent upon the measured dielectric constant and the estimated dielectric constant.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a typical heat transfer device in the form of an air conditioner that is utilized with an embodiment of the present invention;

FIG. 2 is a schematical cross section view of an embodiment of a moisture detection device of the present invention that can be connected to the heat transfer device of FIG. 1; and

FIG. 3 is a schematical flow chart illustrating the steps of the moisture detection apparatus of FIG. 2 in evaluating the moisture content of the refrigerant/oil mixture of the heat transfer device of FIG. 1.

Corresponding reference characters indicate corresponding parts throughout the several views. The exemplifications set out herein illustrate one embodiment of the invention and such exemplifications are not to be construed as limiting the scope of the invention in any manner.

### DETAILED DESCRIPTION OF THE INVENTION

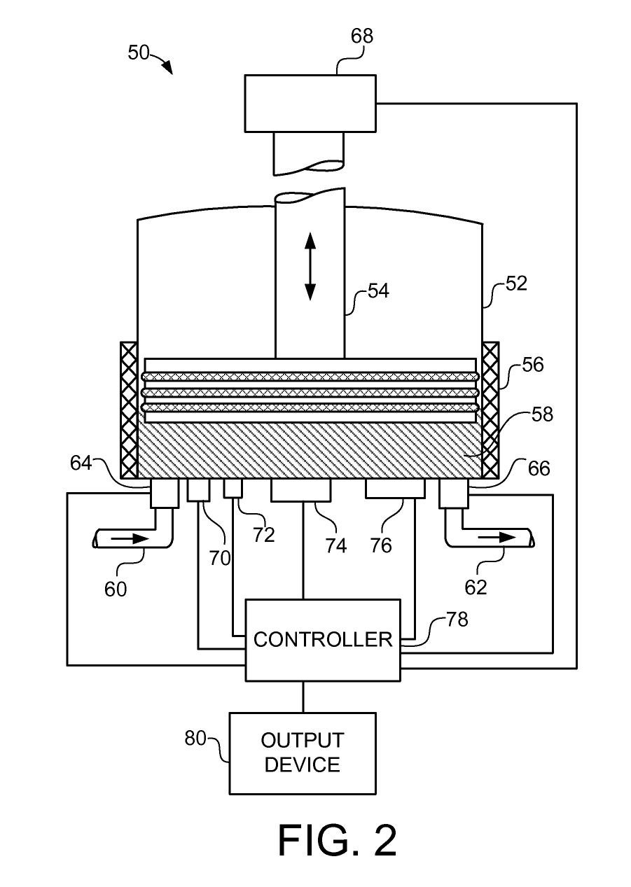

Referring now to the drawings, and more particularly to FIG. 2, there is illustrated a moisture detection apparatus 50 that includes a cylinder 52, a piston 54, a heater/cooler 56, with a mixture under test 58 illustrated as being within the boundaries of chamber 52 and piston 54. Moisture detecting apparatus 50 further includes a sample inlet 60, a sample return 62, valves 64 and 66, an actuator 68, a gas identifier 70, a temperature sensor 72, a dielectric sensor 74, a refractometer 76, a controller 78, and an output device 80.

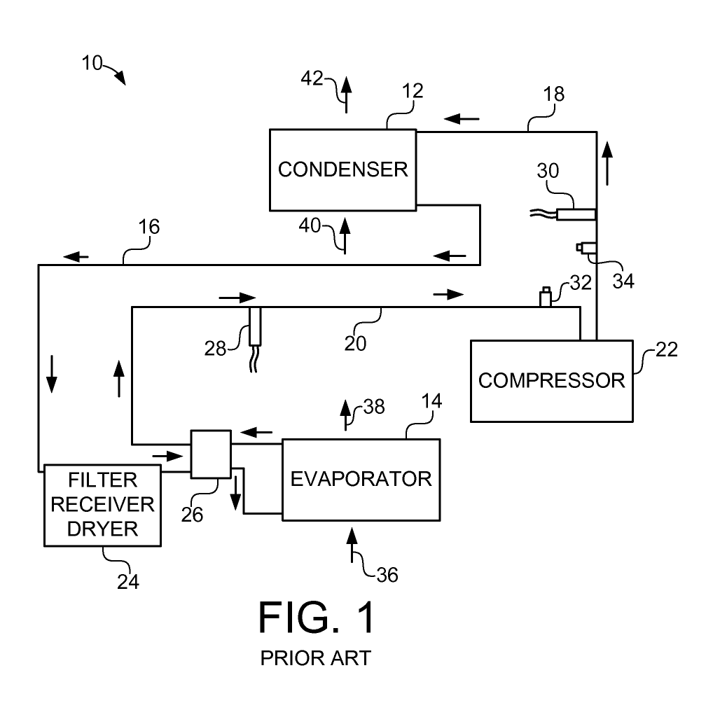

Piston 54 is sealed to cylinder 52 and is variable in its position as illustrated by the dual-headed arrow in FIG. 2. Actuator 68 moves piston 54 to vary the volume of the mixture under test 58. Actuator 68 is under the control of controller 78 and positions piston 54 as commanded by controller 78. The moisture detection apparatus additionally utilizes sample inlet 60 and sample return 62, which may be attached respectively to service ports 34 and 32 of heat transfer device 10 shown in FIG. 1. Such a connection may be permanent with moisture detection apparatus 50 being permanently assigned to heat transfer device 10. Alternatively, moisture detection apparatus 50 may be temporarily connected to service ports 32 and 34 for the obtaining of a sample of the refrigerant/oil mixture, testing the sample and then returning the sample to heat transfer device 10. Valves 64 and 66 serve to isolate mixture 58 that is under test from the rest of the refrigerant/oil mixture of heat transfer device 10. This allows a controlled amount of mixture 58 to be contained in moisture detection apparatus 50.

Mixture 58 may be cooled or heated with heater/cooler 56 with the temperature of mixture 58 being detected by temperature sensor 72. The gas and oil type may be known and that information may be input into controller 78 by conventional means. Otherwise, gas identifier 70 is utilized to detect the type of refrigerant contained in mixture 58. Dielectric sensor 74 is in fluid communication with sample 58 so that the dielectric constant of mixture 58 may be determined. Refractometer 76 is in communication with mixture 58 for the determination of the refractive index of mixture 58. Signals are produced by gas identifier 70, temperature sensor 72, dielectric sensor 74, and refractometer 76 that are received by controller 78. Controller 78 processes the signal received from these devices to determine the moisture content of mixture 58. Although mixture 58 is referred to as a refrigerant/oil mixture, that terminology is not meant to exclude the presence of moisture, which is detected by moisture detection apparatus 50. Results from the determination of the moisture detection process carried out by controller 78 is output onto output device 80 to indicate information about mixture 58, including the moisture content thereof. Additionally, it is contemplated that output device 80 may display the type of refrigerant, the type of oil, the outputs of the signals from gas identifier 70, temperature sensor 72, dielectric sensor 74, and refractometer 76, as well as maintenance and calibration information related to the components of moisture detection apparatus 50. Output device 80 may additionally display information regarding the status of the testing as the testing of mixture of 58 is undertaken. Output device 80 may also output printed information, provide data for downloading and be in communication with data devices of various sorts and by various communication schemes.

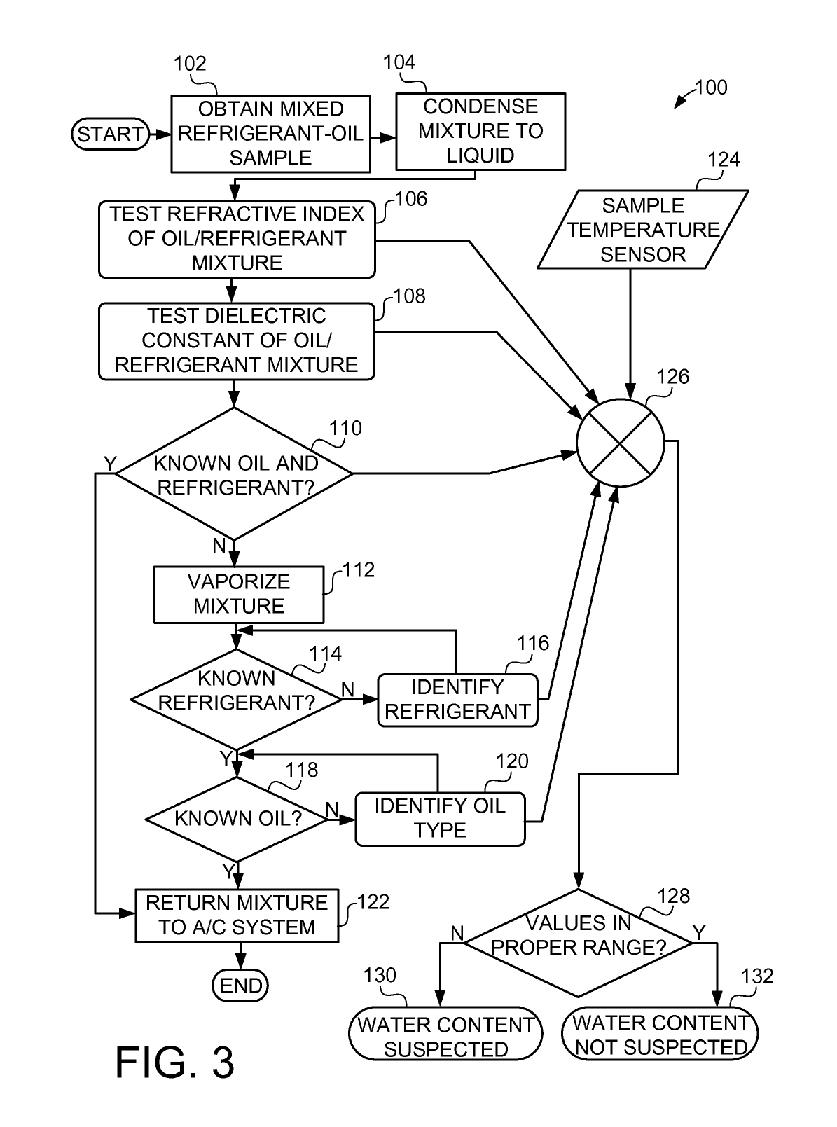

Now, additionally referring to FIG. 3, there is illustrated the steps carried out by controller 78 as it interacts with the elements of moisture detection apparatus 50. Method 100 includes several steps including a step 102 in which the refrigerant/oil mixed sample is obtained by moisture detection apparatus 50. This may include the steps of closing valve 66, opening valve 64, and moving piston 54 within cylinder 52 to increase the volume therein. Once the refrigerant/oil sample is obtained within moisture detection apparatus 50 and valve 64 is closed, the mixture is condensed to a liquid at step 104, which may be by a combination of cooling by the use of heater/cooler 56 or by compression by the movement of piston 54. The liquid of mixture 58 is then tested utilizing refractometer 56 to determine the refractive index of the oil/refrigerant mixture 58, at step 106. Information from step 106 is transferred to block 126, represented schematically herein as a circle with an X in it, identified as block 126, which may be controller 78 using algorithms, or combination of hardware and software to carry out the moisture detection steps of method 100.

At step 108, dielectric sensor 74 tests the dielectric constant of the oil/refrigerant mixture and sends the results to controller 78 represented again as block 126. The refractive index of mixture 58, along with the dielectric constant of mixture 58, coupled with the temperature as determined in block 124 can be utilized to determine the moisture content of mixture 58. The measured dielectric constant is compared to a calculated dielectric constant, which results from the refractive index measurement of mixture 58. The difference between the measured dielectric constant and the computed dielectric constant represents a variance caused by moisture in mixture 58. With this information, controller 78 can determine at step 128 whether the moisture content is in the proper range. If the answer is No, then a message is output onto output device 80 at step 130 indicating that the water content is higher than expected and a message such as “water content is suspected” may be displayed on output device 80. If, at step 128, the value is in a proper range, then no water content is suspected and such a message is displayed at step 132 on output device 80. Alternatively, numeric values that are calculated representative of moisture content can be displayed on output device 80.

If, in method 100 the type of oil and/or refrigerant are not known, then method 100 proceeds to step 110 and, at step 112, with mixture 58, or at least a portion of it, being vaporized and gas identifier 70 is utilized to identify the refrigerant gas and the oil in steps 114, 116, 118, and 120. The type of oil is determined after the vaporization of the refrigerant, which leaves the oil in a liquid state. The type of oil can then be inferred by a dielectric measurement of the oil alone. For example, Polyalkylene glycol (PAG) oil has a higher dielectric constant than Polyolester (POE) oil. Method 100 illustrates that if only the refrigerant or the oil are known, then that portion of method 100 can be skipped. Otherwise, the identification of the refrigerant and type of oil are also utilized at block 126 so that controller 78 can then determine what the dielectric constant and refractive index should be for the now identified refrigerant and oil. As mentioned previously, the identification of the refrigerant and oil type can be input into controller 78 so that steps 112 through 120 may be skipped over by proceeding from step 110 to step 122.

At step 122, mixture 58 is returned to heat transfer device 10. The return of mixture 58 can be accomplished by ensuring that valve 64 is closed, opening valve 66, and actuating actuator 68 to reduce the volume contained in the combination of cylinder 52 and piston 54 by reducing the displacement thereof.

Gas identifier 70 may utilize a commercially available gas identifier or utilize one that is custom made for moisture detection apparatus 50. Dielectric sensor 74 may be two spaced apart electrodes in contact with mixture 58 connected to circuitry that is sensitive to the capacitance across the electrodes. A voltage that is proportional to the dielectric constant of the fluid is generated and the measure of the dielectric constant can be computed based upon the application of a known voltage on the electrodes that are spaced a known distance apart. Refractometer 76 may utilize a lens and prism or may utilize the technique of measuring the velocity of different colors of light within mixture 58.

It is known that refractive index of a refrigerant/oil mixture varies by the refrigerant volume fraction thereof. This is one of the items that is utilized to additionally determine the water content by being able to discern the relative volumes of the refrigerant and oil in refrigerant/oil mixture 58. The refractive index, or index of refraction, is a measure of the speed of light in that particular substance. The ratio of the speed of light in a vacuum relative to the speed of light in the tested medium is the measure of the refractive index. It is believed that the velocity at which light travels in a vacuum is a physical constant; however, light travels at a slower speed through a given material, such as mixture 58. The refractive index is equal to the velocity of light in a vacuum divided by the velocity of the light in mixture 58. For example, the refractive index of water is 1.33, meaning that light travels 1.33 times as fast in a vacuum than it does in water. The refractive index may vary based on the wavelength of light. It is known that there is a relationship of the dielectric constant to the refractive index, with the dielectric constant being the square of the complex numeric rendition of the refractive index.

The present invention advantageously allows the quick measurement of moisture of a refrigerant/oil mixture 58 within a heat transfer device 10 to thereby determine whether the system 10 should continue to operate or other action should be taken such as steps to remove the moisture therein. Another advantage of the present invention is that it can be utilized with legacy air conditioner systems without modification of the mechanical system. Controls can be further integrated to utilize the results from the moisture testing apparatus to determine whether continued use of the heat transfer device should be contemplated or discontinued. In addition to the two pressure switches 28 and 30, which are in place to ensure the proper amount of refrigerant/oil mixture is present, the present invention can determine whether too much moisture is present and can be wired into the system to shut heat transfer device 10 down in the event that the level of moisture is too high within refrigerant/oil mixture 58. Yet another advantage of the present invention is that it can be easily connected, the system tested, and the moisture detection apparatus removed, similar to other pieces of test equipment that may be connected to service ports 32 and 34. The present invention provides a simple, portable system to test for moisture content while returning the test sample to the refrigerant in the system to preclude the escape of refrigerants into the atmosphere.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A heat transfer device, comprising:
an evaporator;
a condenser;
a compressor fluidly coupled to said evaporator and said condenser;
a refrigerant-oil mixture routed to said compressor, said evaporator and said condenser; and
an apparatus for moisture detection in the refrigerant-oil mixture, the apparatus being in fluid communication with the mixture, the apparatus including:
a refractive index determining device producing a first signal representative of a refractive index of the mixture;
a dielectric constant determining device producing a second signal representative of a dielectric constant of the mixture; and
a controller receiving said first signal and said second signal, said controller determining a moisture content of the mixture dependant upon said first signal and said second signal.

2. The heat transfer device of claim 1, further comprising a temperature sensor generating a third signal representative of a temperature of the mixture, said temperature sensor being in thermal contact with the mixture, said controller receiving said third signal, said controller additionally using said third signal to determine the moisture content of the mixture.

3. The heat transfer device of claim 2, further comprising a gas identifying device in contact with the mixture, said gas identifying device producing a fourth signal representative of at least one of an identification of the refrigerant and an identification of the oil in the mixture, said fourth signal being communicated to said controller.

4. The heat transfer device of claim 3, wherein said gas identifying device vaporizes a portion of the mixture before producing said fourth signal.

5. The heat transfer device of claim 4, wherein said fourth signal includes information relative to both said identification of the refrigerant and said identification of the oil in the mixture.

6. The heat transfer device of claim 2, further comprising an output device, said controller sending information to said output device relating to the moisture content of the mixture.

7. The heat transfer device of claim 1, further comprising a variable volume container fluidly coupled to the mixture, said refractive index determining device and said dielectric constant determining device coupled to a wall of said container.

8. The heat transfer device of claim 7, wherein a portion of the mixture enters into said container and once the moisture content of the mixture is determined the mixture in said container is substantially expelled from said container.

9. An apparatus for moisture detection in a refrigerant-oil mixture of a heat transfer device, the apparatus for moisture detection comprising:
a refractive index determining device producing a first signal representative of a refractive index of the mixture;
a dielectric constant determining device producing a second signal representative of a dielectric constant of the mixture;
a variable volume container fluidly coupled to the mixture, said refractive index determining device and said dielectric constant determining device coupled to a wall of said container; and
a controller receiving said first signal and said second signal, said controller determining a moisture content of the mixture dependant upon said first signal and said second signal.

10. The apparatus for moisture detection of claim 9, further comprising a temperature sensor generating a third signal representative of a temperature of the mixture, said temperature sensor being in thermal contact with the mixture, said controller receiving said third signal, said controller additionally using said third signal to determine the moisture content of the mixture.

11. The apparatus for moisture detection of claim 10, further comprising a gas identifying device in contact with the mixture, said gas identifying device producing a fourth signal representative of at least one of an identification of the refrigerant and an identification of the oil in the mixture, said fourth signal being communicated to said controller.

12. The apparatus for moisture detection of claim 11, wherein said gas identifying device vaporizes a portion of the mixture before producing said fourth signal.

13. The apparatus for moisture detection of claim 12, wherein said fourth signal includes information relative to both said identification of the refrigerant and said identification of the oil in the mixture.

14. The apparatus for moisture detection of claim 10, further comprising an output device, said controller sending information to said output device relating to the moisture content of the mixture.

15. The apparatus for moisture detection of claim 9, wherein a portion of the mixture enters into said container and once the moisture content of the mixture is determined the mixture in said container is substantially expelled from said container.

16. A method of determining a moisture content of a refrigerant-oil mixture of a heat transfer device, the method comprising the steps of:
testing the mixture to determine a refractive index of the mixture;
testing the mixture to determine a measured dielectric constant of the mixture;
estimating a dielectric constant of the mixture dependent on said refractive index; and
determining the moisture content of the mixture dependent on said measured dielectric constant and said estimated dielectric constant.

17. The method of claim 16, further comprising the step of measuring a temperature of the mixture with a temperature sensor in thermal contact with the mixture, said determining step additionally using the temperature of the mixture to determine the moisture content of the mixture.

18. The method of claim 17, further comprising the step of identifying gases in the mixture including at least one of an identification of the refrigerant and an identification of the oil in the mixture.

19. The method of claim 18, wherein said identifying step includes the step of vaporizing a portion of the mixture.

20. The method of claim 16, further comprising the step of drawing a portion of the mixture into a variable volume container, a refractive index determining device and a dielectric constant determining device coupled to a wall of said container.
